(19) United States
(12) Patent Application Publication
(10) Pub. No.: US 2006/0155634 A1
(43) Pub. Date: Jul. 13, 2006

(54) Novel construction contractors bidding system and method

(76) Inventor: Bernard Woodard, Cottage Grove, OR (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/036,286

(22) Filed: Jan. 13, 2005

(51) Int. Cl. G06Q 40/00

(52) U.S. Cl. 705/37

(57) ABSTRACT

A method for controlling the bidding of construction contracts and subcontracts, and generating competitive quality bids; employing a central manager or contracting specialist, to obtain a list of project contract plans and specifications; identifying a plurality of specialty trade contractors within a region; and distributing the project contract plans and specifications to a plurality of remote quantification specialists to prepare QTOs to electronically return to CCEs and contractors; for final unit pricing amounts to be added and final bids submitted to general contractors, owners, government, etc., on construction contract projects being built or remodeled in the United States.

### FIELD OF THE INVENTION

The present invention is directed to the field of construction bidding systems. In particular, the present invention is directed to a system and method whereby construction specialty contractors can submit quantitatively accurate bids, with the local market rate for the specialty trade item properly considered in the final submitted bid amount.

### BACKGROUND OF THE INVENTION

Most small specialty contractors are either unfamiliar with blueprints or lack the time to do accurate and/or consistent quantitative take-offs. A Quantitative Take-Off (QTO) is the specific area and unit calculations for a construction project and are critical elements of the competitive bidding process for a construction contract. The QTO includes the total number of units, and/or square footage of the area of items to be supplied and/or installed on specific construction projects.

Small specialty contractors typically know their business very well but they cannot get and perform consistent profitable contracts. It is often difficult for small companies to accurately estimate their portion of work for upcoming construction projects.

Most construction project contracts in the United States, are performed by general contractors, whom have bid against other general contractors on a specific bid date, and normally on a competitive basis. These general contractors take bid day bids from specialty trade contractors for most of trades involved in the project being bid on. Whichever specialty trade contractor is low bid, for his trade, on bid day, with the successful low general contractor, usually gets a contract for his scope of work. Basically the reason for general contractors is that they package together specialty contractors needed on a specific project, include them into one general contract bid and offer the customer a package so that he does not have to identify and hire each specialty contractor himself.

The small specialty contractors are the catalyst of the construction industry but rarely reach their profit or growth potential. They usually are the ones doing the work as a subcontractor to a subcontractor, which puts them at the bottom of the construction food chain. They know their application/installation of particular trade/products better than anyone else. They simply need help with their project estimating balance to help them have more consistent contracts coming to them. These small specialty contractors know the quantity of how much work they should perform in a given period of time for their specific trade. And they know these numbers far better than anyone else does.

Draftsmen, by using reverse engineering, know quality extraction from a set of blueprints can create an accurate QTO, but most know nothing of specific performance quotas for each of the trade specific trades on construction projects.

Both draftsmen and tradesmen are needed for a quality construction bid. Without a proper quantity take-off, tradesmen often bid too high and miss the job or too low and get a job he cannot make money on. Without knowledge of application, a draftsman would not know accurate numbers for unit pricing and would only have a worthless quantity take-off. This invention puts the best of both together in order to provide quality and affective bids for the contractor.

There have been a number of patents directed to the field of construction bid systems. U.S. Pat. No. 5,918,219 discloses a distinctive estimating method using a concise depiction, organization, and presentation of time, related to the number of items accomplished, to produce a Historical Data Block of information, that is a stable inference base. These Blocks of information can be stored, referenced, anatomized, multiplied or divided and restacked, to create other accurate totals and estimates. This stable Block easily allows the accurate calculation of future duration times and item quantity totals. The calculated item quantities can be used to calculate current item costs and totals, by using a current item cost database. Or the item totals can be printed and sent out, requesting a quote, or sent out as purchase orders. The accurate duration times can be used to automatically produce a schedule, concurrently with the estimate, by using a predefined template. These duration times can also be used to calculate accurate: duration costs, employee goals for profit sharing, payroll, and insurance premiums, all of which increase the efficiency of management and the estimating processes.

U.S. Pat. No. 6,324,508 discloses a method for performing a construction quantity takeoff estimate of a drawing representative of a construction project having a plurality of items includes applying first vocal indicia representative of a selected item of the plurality of items to a voice recognition system and producing and first electrical signals representative of the first vocal indicia by the voice recognition system. The selected item is first determined by the voice recognition system in accordance with the first electrical signals. Second vocal indicia representative of a quantity of the selected item are applied to the voice recognition system and second electrical signals representative of the quantity of the selected item are produced. The quantity of the selected item is second determined by the voice recognition system in accordance with the second electrical signals. The takeoff estimate is performed in accordance with the first and second determining.

U.S. Pat. No. 6,393,410 the invention relates to a process for estimating a construction project over a computer network. The first step in the process starts when an architect or contractor enters information relating to at least one construction project into an online database. This online database is stored on a server creating a series of quantities for each of the at least one construction projects. Next, a system host presents a series of quantities for each of the at least one construction projects. Next, users such as contractors, subcontractors or construction managers can purchase and download these quantities and a construction report. These quantities are presented in a unique electronic spreadsheet template. Once the users have this template with the quantities included, they can bid on each construction project either online or through any other communication means.

U.S Patent Application 20040205014 discloses a system where Construction project bid information is determined by providing a task database containing a number of tasks. Each task includes a required labor amount. A database of labor rate data also is provided. Drawing data for the construction project is received, which includes structures. The structures are mapped to tasks in the task database to form project elements. A construction cost is determined for each project element based at least in part on the required labor amount for the respective mapped task and labor rate data. The construction costs of the project elements are compiled to obtain a total project cost.

U.S. Patent 20030101127 The present invention provides an Internet-based construction bid management system that can be accessed and utilized by construction project owners, general contractors, subcontractors, vendors, and other parties interested in the construction bidding process. The system accommodates the posting of projects, the submission of bids, the distribution of construction drawings, and the collection of historical bid results, via any number of networked computer devices. The automated nature of the system ensures that the current bid status of any number of projects can be quickly updated for immediate access by the various participants

U.S. Pat. No. 6,718,312 discloses a method and system for dynamic combinatorial auctions employing bid composition restrictions is disclosed. Three exemplary types of bid composition restrictions, which may be applied either singly or in combination, are disclosed: non-additive activity restrictions, subset restrictions, and superset restrictions. These restrictions produce more efficient auction outcomes by placing extra constraints on bidders who specify larger combinations in their bids, thereby penalizing attempts at strategic bidding without ruling out genuine attempts to avoid an exposure problem.

U.S. Published App. No. 20030212627 shows a computerized system for auctioning bids on construction projects, comprising: at least one server computer having a processor, an area of main memory for executing program code under the direction of the processor, a storage device for storing data and program code, and a bus connecting the processor and the storage device; at least one relational database stored on said storage device; a data communications device connected to said bus for connecting said server computer to a computer network; a Web-based multi-stage auctioning of construction project computer program code stored in said storage device and executing in said main memory under the direction of said processor, the computer program including: means for entering into the computerized system and validating member credentials; means for accessing the construction projects, planning locations and registering to bid on the construction projects; means for providing information relative to a type of contract the construction projects will have; means for providing an optional pre-bid stage to determine if contractors are within a competitive range; means for providing a multi-stage auction process, including default posting of a low bid for every stage; means for sorting, accepting and rejecting bids for the construction projects; means for posting a low bid and providing a comprehensive project report to the owner and developer for their evaluation of the winning bid compared to their budget; means for having the winning bid reviewed by an owner and developer and architect of the construction project; means for having nonmember contractors applying for the construction projects; and means for having nonmember contractors selecting states and counties of participation and issuance of identification and password selection.

While there have been a number of systems, none have adequately addressed the needs of specialty contractors to economically create competitive bids. None of these systems have provided an adequate system for acquiring and completing QTOs to the procurement of construction contracts.

It is an object of the present invention to provide a system in which quantitative take offs can be prepared for specific projects being built in the United States.

It is a further object of the present invention to provide a system in which quantitative take offs can be created and sent electronically, mailed, etc. to clients in bid ready form.

It is still a further object of the present invention, to provide a system in which a foreign or remote service can prepare QTO's for a single or plurality of contractors, and/or specialty trade contractors, for construction projects being built and/or remodeled, at any location in the United States.

These and other objects of the invention will become apparent from the detailed description.

### SUMMARY OF THE INVENTION

A method for controlling the bidding of construction subcontracts or contracts, and generating competitive bids, employing a central manager to obtain project plans and specifications, identifying a plurality of specialty trade contractors within a region, and distributing the contract plans and specifications to a plurality of remote quantification processing centers to prepare QTOs and/or bids on the construction project being built or remodeled in the United States.

A further embodiment of the present invention includes a plurality of remote quantification centers in a plurality of remote countries.

Yet another embodiment of the present invention includes a method where each of said remote quantification centers in a particular geographic region or construction category.

A method for remotely producing quantitative take-off for a plurality of projects aggregating a plurality of construction contract plans and specifications and distributing the plans and specifications to a plurality of remote quantitative processing centers who generate quantitative take-offs for a portion of the contract specifications.

### BRIEF DESCRIPTION OF THE FIGURES

FIG. 1 is a block diagram of the operation of the system in accordance with the present invention.

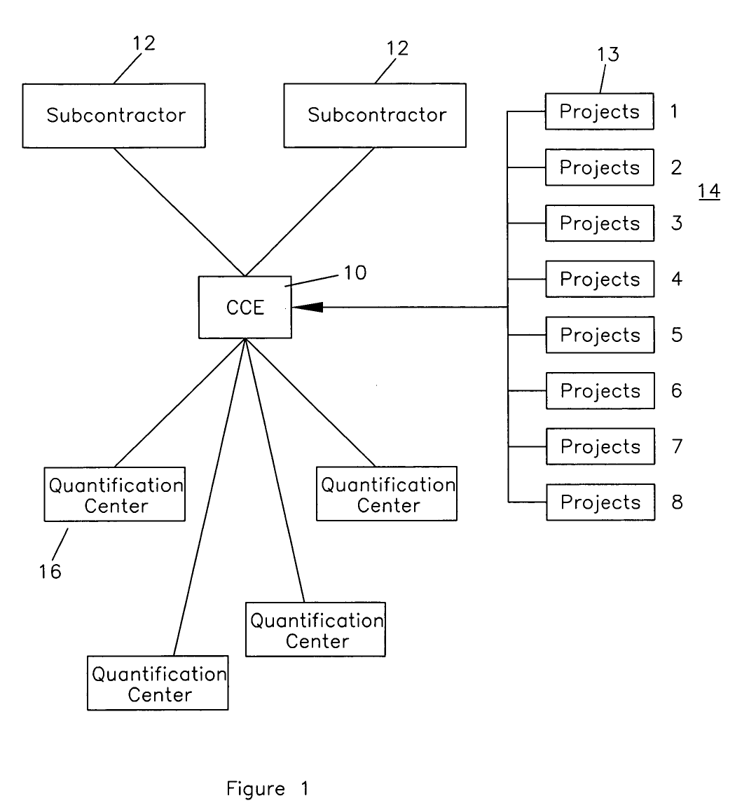

FIG. 2 is a block diagram of a regional system in accordance with the invention.

FIG. 3 is an enhanced block diagram of the invention.

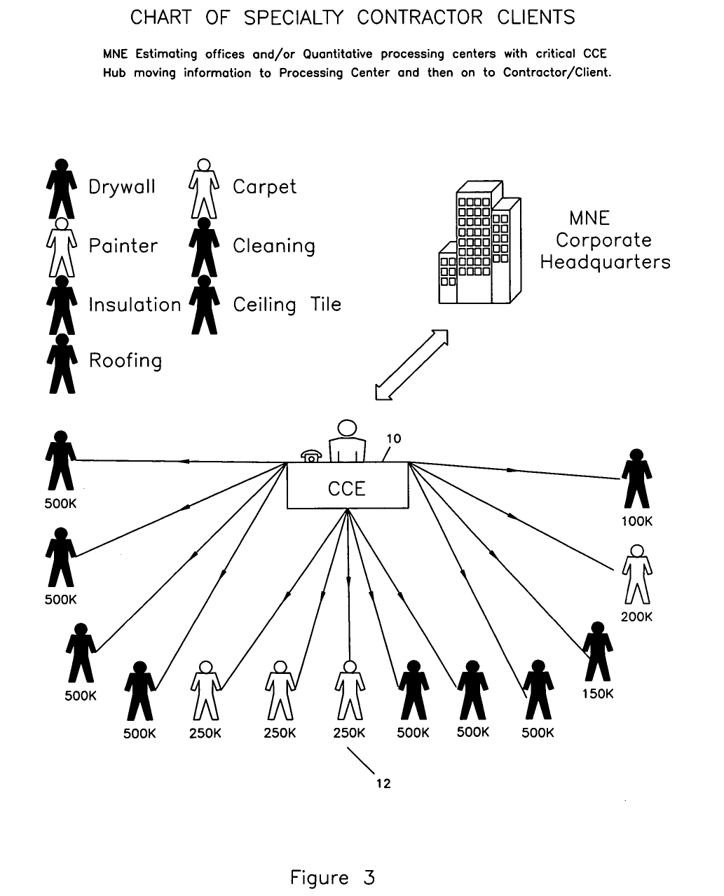

FIG. 4 illustrates the generation of QTO's using the present invention.

FIG. 5 is a further flow chart in accordance with the invention which illustrates the material supplier approval process.

FIG. 6 is a QTO generated in accordance with the present invention.

FIG. 7 illustrates the process for general contractor estimating.

### DETAILED DESCRIPTION OF THE INVENTION

The present invention is described with reference to the enclosed figures. The present invention is directed to a system for controlling and managing bids for a plurality of sub-contractors and specifically the bids of subcontractors for a project.

The system incorporates several vertical layers. The initial layer is a contractor estimating specialist or contract coordinating engineer (CCE) 10. The CCE 10 has the job of identifying contracts or projects out for bid 13 within a region or area. The manager 10 will obtain the blueprints and specifications for the particular bidding projects such as a hospital building or office. Many of thse are available on publicly available websites. Specifically, this individual will receive information on each job, assist in inputting construction market rates for the area, and assist in submitting the final bids for their clients to general contractors and/or owners. The CCE 10 will track previous bids and successful awards and contracts in order to better know the current market rate for each specialty trades function.

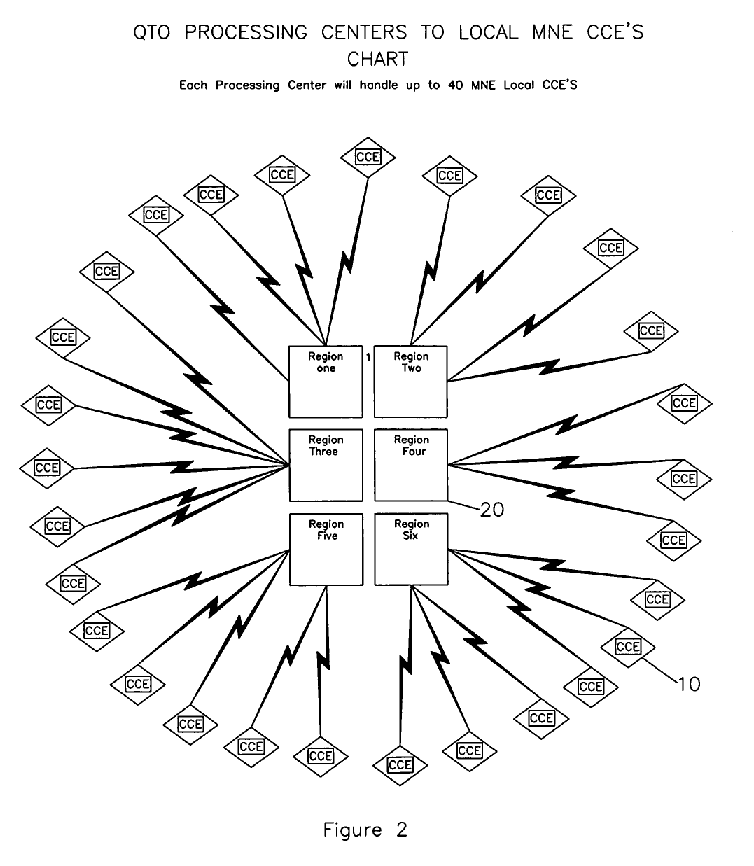

The CCE 10 will have access to and work with a group of specialty trade contractors 12 with a specific region. Each specialty trade contractor 12 will work in one of a variety of trades, including, but not limited to, drywall, painting, roofing, ceramic tile, framing, insulation, carpeting, masonry, acoustic ceiling, etc. The specialty trade contractors 12 will typically be found in one of a group of geographic areas. As shown in FIG. 2, the nation may be broken down into a series of regions.

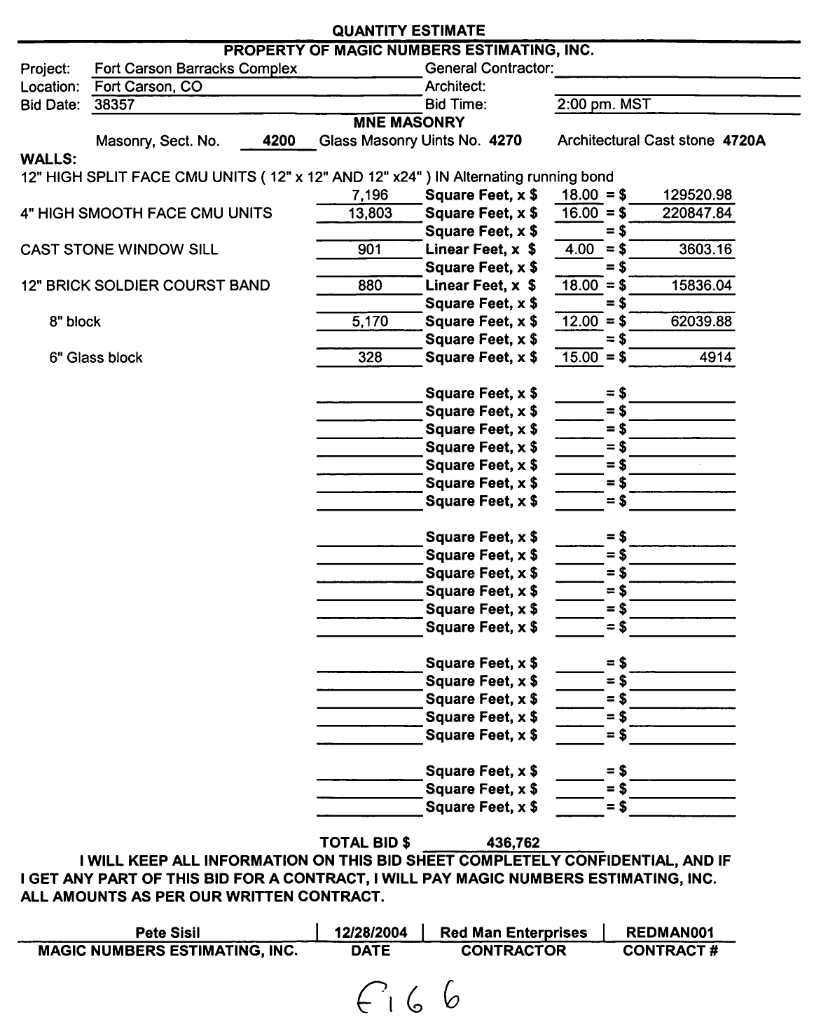

Based upon the needs of the contractor, specific project plans and specifications will then be sent electronically, or by other means, to a quantification processing center 16. The quantification processing center 16 is preferably remote and it may be located in a foreign country. Each quantification processing center 16 will preferably be restricted to a particular region or specialty. This will permit the quantification processing centers 16 to develop expertise in areas of specialty (e.g., carpentry, flooring) or specific region of the country. The quantification processing center will use high speed internet and utilize specialized software to take blueprints and generate QTOs therefrom. An example of a QTO is attached as FIG. 6. The CCE 10 and Sub-contractor 12 take the QTO and input the financial rates for a specific region.

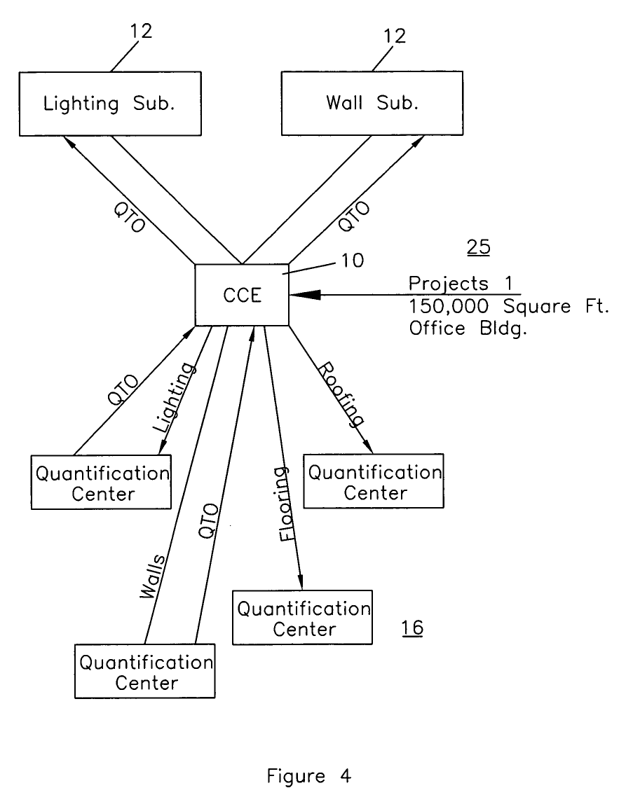

The present invention thus provides a system to assist special trade contractors in procuring contracts from general contractors, builders, owners, government, etc. Referring to FIG. 4, after the QTO is generated, it is forwarded to the CCE 10 and onto the specific specialty trade contractor 12 who will insert unit pricing and submit his or her final bid. If the bid is successful, the CCE 10 receives a percentage of the contract award.

Each final QTO sheet may cover any trade on the construction project inclusive, but not limited to, drywall, painting, roofing, insulation, carpentry, etc. and is completed by a trained data technician from either a domestic or foreign quantification processing center. The QTOs are then transferred via internet, fax, etc. to the specialty trade contractor for submission of bids on a United States construction project.

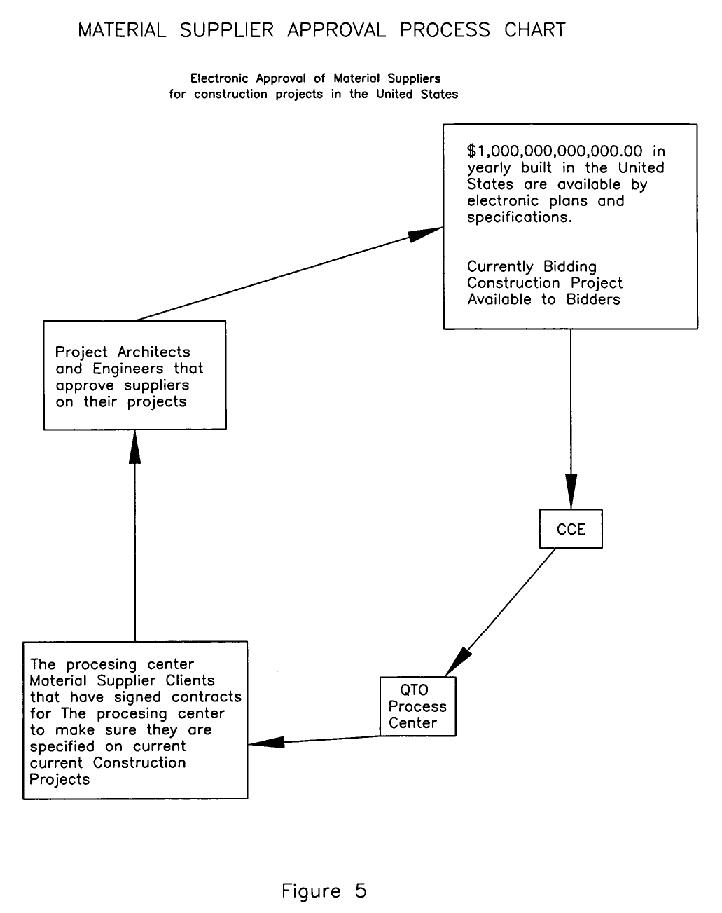

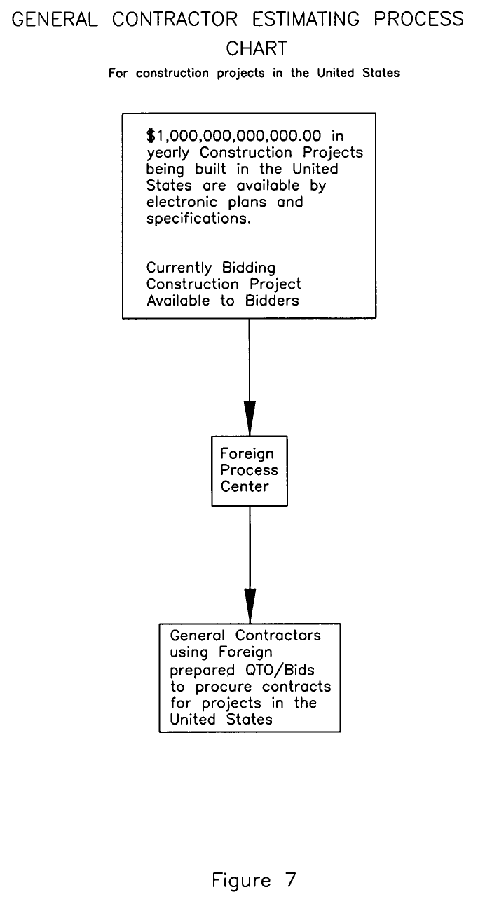

Referring to FIGS. 5 and 7, the over all operation of the invention is shown. As shown in FIG. 5, a huge volume of contracts are made available by electronic plans. These are acquired by the CCE's 10 who forward them to the QTO processing centers 12. The QTOs are then forwarded to the sub-contractor who put in financial values. These are then submitted for approval.

In FIG. 7, the contracts are sent directly to the foreign processing center where QTO's are generated and then on to the general contractors to procure bids.

The invention also supplies QTOs for all possible trades on the project, not just one of the specialty trades, and it is done from a different area of the construction work itself, even the foreign processing center.

The present invention suggests several embodiments. The system may use a foreign based quantification processing center 16 whereby at least one person completes a bid ready Quantitative Take Offs (QTOs) for any type of construction being built in the United States (US).

In a second embodiment, the quantification center is a foreign based quantification processing center whereby at least one person completes a bid ready Quantitative Take Offs (QTOs) for any type of construction being built in the United States (US). The system then sends those QTOs electronically via internet, fax, and/or any new electronic technology to the CCE 10 in the US; or directly to the specialty trade contractor 12 in the United States for finalizing a construction bid on projects located in the US.

In a third embodiment, the system uses a US based QTO Quantification Processing Center whereby at least one person completes a bid ready Quantitative Take Offs (QTOs) for any type of construction being built in the United States (US). The system then sends those QTOs electronically via internet, fax, and/or any technology to a CCE representative in the US; or directly to the specialty trade contractor in the United States for finalizing a construction bid on projects located in the US.

Finally, the system may use a US or Foreign based quantification processing center whereby at least one person analyzes the plans and specifications for specified approved suppliers of any type of construction being built in the US. Then assists, via electronic communication, non-specifically approved U.S. or Foreign suppliers in getting approval to be used on a specific construction project in the US.

The invention also envisions the process of supplying QTOs to clients based solely upon receiving a fee from our clients based upon success of their receiving a contract. The invention also embodies a process of supplying QTOs to a plurality of different types of specialty trade contractors in a given area; and the process of having a CCE or any bidding specialist in a given area assist a plurality of different types of specialty trade contractors submit bids to owners, general contractors, etc.

The present invention has been described with reference to the enclosed preferred embodiment. It is to be appreciated that the true nature and scope of the invention is to be determined with reference to the attached claims.

1. A method for controlling the bidding of subcontracts and contracts, and generating competitive bids;
employing a central manager to obtain a list of bidding project plans and specifications;
identifying a plurality of specialty trade contractors within a region;
distributing the bidding project plans and specifications to a plurality of remote quantification processing centers to prepare QTOs and bids on the projects located in the United States.

2. The method of claim 1 wherein the plurality of remote quantification processing centers are in a plurality of remote countries.

3. The method of claim 1 where each of said remote quantification processing centers in a particular geographic region or construction category.

4. A method for remotely producing quantitative take-off for a plurality of projects:
aggregating a plurality of construction project plans and specifications; and
distributing the plans and specifications to a plurality of remote quantitative processing centers who generate bid ready quantitative take-offs for a portion of the project contract specifications.
